(19) United States
(12) Patent Application Publication
(10) Pub. No.: US 2025/0322522 A1
(43) Pub. Date: Oct. 16, 2025

(54) MEDICAL IMAGE PROCESSING APPARATUS, MEDICAL IMAGE PROCESSING METHOD, AND STORAGE MEDIUM

(71) Applicant: ZIOSOFT, INC., Tokyo (JP)

(72) Inventor: Yusuke INOUE, Tokyo (JP)

(21) Appl. No.: 19/089,614

(22) Filed: Mar. 25, 2025

(30) Foreign Application Priority Data
Apr. 10, 2024 (JP) 2024-063581

(51) Int. Cl. G06T 7/00

(52) U.S. Cl. CPC G06T 7/0014; G06T 2207/30048

(57) ABSTRACT

A medical image processing apparatus includes: a processor configured to display a reference image obtained by visualizing a reference plane on a display along with three end points contained in the reference plane, display a first image obtained by visualizing a first plane on the display simultaneously with the reference image, along with one or two end points contained in the first plane, display a second image obtained by visualizing a second plane on the display simultaneously with the reference image, along with one or two end points contained in the second plane, receive an input operation of moving at least one of the three end points via user interface, and update the reference plane by moving at least one of the three end points based on the input operation.

### CROSS-REFERENCE TO RELATED APPLICATIONS

This application is based on and claims priority under 35 USC § 119 from Japanese Patent Application No. 2024-063581 filed on Apr. 10, 2024, the contents of which are incorporated herein by reference.

### TECHNICAL FIELD

The present disclosure relates to a medical image processing apparatus, a medical image processing method, and a storage medium storing a medical image processing program.

### BACKGROUND

Conventionally, TAVI is known as a surgical method for a subject. TAVI stands for transcatheter aortic valve implantation. TAVI refers to transcatheter aortic valve replacement. TAVI is also referred to as TAVR. TAVR stands for transcatheter aortic valve replacement. When establishing a surgical plan for TAVI, aortic valve measurement is performed. Specifically, the annular plane in the aortic valve is acquired, and the perimeter or diameter of the annular plane is measured.

A conventional method for determining the annular plane is known (Non Patent Literature 1). In the method in the Non Patent Literature 1, points in the cross-sections of the aortic valve drawn on an axial plane, a sagittal plane, and a coronal plane of the aortic valve are manipulated so as to determine three lowest points of coronary cusps contained in the annular plane, as shown in Section 3.1 and FIG. 1. In this case, each of the axial plane, the sagittal plane, and the coronal plane is rotated within the plane, or the planes are moved in parallel, without changing the perpendicular relationship among the planes.

Non Patent Literature 1: “Computed tomography imaging in the context of transcatheter aortic valve implantation (TAVI)/transcatheter aortic valve replacement (TAVR): An expert consensus document of the Society of Cardiovascular Computed Tomography”, Philipp Blankea, Jonathan R. Weir-McCallb, Stephan Achenbachc, Victoria Delgadod, Jorg Hausleitere, Hasan Jilaihawif, Mohamed Marwanc, Bjarne L. Norgaardg, Niccolo Piazzah, Paul Schoenhageni, Jonathon A. Leipsica, Journal of Cardiovascular Computed Tomography 13 (2019) 1-20

In the method in the Non Patent Literature 1, it is difficult to accurately determine the annular plane, and there is room for improvement. Similarly, it is assumed that determining a plane serving as an index in a site in a subject having three or more cusp-shaped structures, such as the annular plane of the aortic valve, is difficult.

The present disclosure provides a medical image processing apparatus, a medical image processing method, and a storage medium storing a medical image processing program that can improve the accuracy of determining a plane serving as an index in a site in a subject having three or more cusp-shaped structures.

### SUMMARY

A medical image processing apparatus includes: a processor. The processor is configured to acquire volume data containing three cusp-shaped structures of a subject, set three end points on the most upstream sides of the respective three cusp-shaped structures in the volume data, set a reference plane containing the three end points, sets a first plane that is a plane which contains one or two end points among the three end points and which is perpendicular to the reference plane, set a second plane that is a plane which contains, among the three end points, one or two end points different from the one end point or the combination of the two end points of the first plane and containing all of the three end points together with the end points of the first plane and which is perpendicular to the reference plane, display a reference image obtained by visualizing the reference plane on a display along with the three end points contained in the reference plane, display a first image obtained by visualizing the first plane on the display simultaneously with the reference image, along with the one or two end points contained in the first plane, display a second image obtained by visualizing the second plane on the display simultaneously with the reference image, along with the one or two end points contained in the second plane, receive an input operation of moving at least one of the three end points via user interface, and update the reference plane by moving at least one of the three end points based on the input operation.

A medical image processing method includes: a step of acquiring volume data containing three cusp-shaped structures of a subject; a step of setting three end points on the most upstream sides of the respective three cusp-shaped structures in the volume data; a step of setting a reference plane containing the three end points; a step of setting a first plane that is a plane which contains one or two end points among the three end points and which is perpendicular to the reference plane; a step of setting a second plane that is a plane which contains, among the three end points, one or two end points different from the one end point or the combination of the two end points of the first plane and containing all of the three end points together with the end points of the first plane and which is perpendicular to the reference plane; a step of displaying a reference image obtained by visualizing the reference plane on a display along with the three end points contained in the reference plane; a step of displaying a first image obtained by visualizing the first plane on the display simultaneously with the reference image, along with the one or two end points contained in the first plane; a step of displaying a second image obtained by visualizing the second plane on the display simultaneously with the reference image, along with the one or two end points contained in the second plane; a step of receiving an input operation of moving at least one of the three end points via user interface; and a step of updating the reference plane by moving at least one of the three end points based on the input operation.

### BRIEF DESCRIPTION OF DRAWINGS

FIG. 1 is a block diagram showing a hardware configuration example of a medical image processing apparatus in a first embodiment.

FIG. 2 is a block diagram showing a functional configuration example of the medical image processing apparatus.

FIG. 3 is a diagram showing an example of an annular plane SA containing three lowest points of coronary cusps of an aortic valve.

FIG. 4 is a diagram showing an example of an annular plane SA based on mask setting.

FIG. 5 is a diagram showing an example of an annular plane and three longitudinal planes.

FIG. 6 is a diagram showing an example of the annular plane and nine longitudinal planes.

FIG. 7 is a diagram showing an example of reference lines indicated on an annular plane.

FIG. 8A is a flow chart showing an operation example of the medical image processing apparatus (first part).

FIG. 8B is a flow chart showing the operation example of the medical image processing apparatus (second part).

FIG. 9 is a diagram showing a first example of highlighting a reference line.

FIG. 10 is a diagram showing a second example of highlighting a reference line.

FIG. 11 is a flow chart showing an operation example of a medical image processing apparatus of a second embodiment.

FIG. 12 is a diagram showing an example of reference lines drawn on an auxiliary MPR plane, the reference lines representing the position of a reference MPR plane and the positions of other auxiliary MPR planes.

### DESCRIPTION OF EMBODIMENTS

Hereinafter, embodiments will be described in detail with reference to the drawings as appropriate. However, descriptions that are more detailed than necessary may be omitted. For example, detailed descriptions of matters that are already well-known and descriptions of substantially identical configurations may be omitted. Such descriptions are omitted to avoid unnecessary verbiage of the following description and facilitate understanding by those skilled in the art. It should be noted that the accompanying drawings and the following descriptions are provided to enable those skilled in the art to sufficiently understand the present disclosure and are not intended to limit the subject matter described in the claims.

### Details of Achieving First Embodiment of Present Disclosure

An aortic valve may not be sufficiently closed, or blood flowing out may regurgitate and flow back due to, for example, calcification of the aortic valve or aging. In such cases, TAVI may be performed which can reduce the burden on a patient. In TAVI, an artificial valve is inserted to replace the aortic valve. This artificial valve is expensive.

In TAVI, it is necessary to properly estimate the TAVI valve size that is suitable for the patient prior to the procedure. Determining whether TAVI can be applied to the patient is also necessary. It is important to confirm the size of the valve in the patient, the size of the aorta, and whether there is space in the upstream portion of the aorta (upstream side of blood circulation, that is, the side of the coronary artery and heart). Therefore, in order to determine the type of the artificial valve to be used prior to the TAVI procedure, it is necessary that the aortic valve is measured. While information on an annular plane is needed in the measurement of the aortic valve, acquiring accurate information on the annular plane is difficult.

The aortic valve has three cusps (cusp-shaped structures). The cusp-shaped structures are NCC, RCC, and LCC, respectively. NCC stands for non-coronary cusp and refers to the non-coronary cusp of the aortic valve. RCC stands for right coronary cusp and refers to the right coronary cusp of the aortic valve. LCC stands for left coronary cusp and refers to the left coronary cusp of the aortic valve. The end point on the most upstream side of NCC is referred to as the lowest point of NCC. The end point on the most upstream side of RCC is referred to as the lowest point of RCC. The end point on the most upstream side of LCC is referred to as the lowest point of LCC. The lowest point of NCC, the lowest point of RCC, and the lowest point of LCC are collectively referred to as three lowest points of the coronary cusps. The plane containing the three lowest points of the coronary cusps is the annular plane. In addition, the circle that passes through the three lowest points of the coronary cusps is the annulus. The annular dimension of the annulus is used as an index for estimating the size of the TAVI valve.

A coronary artery arises from the upstream side of LCC and RCC. Therefore, it is required that the ostium of the coronary artery is prevented from being obstructed by the artificial valve that replaces the aortic valve in TAVI. For this reason, it is desired that the perimeter and the diameter of the annular plane are accurately determined in order to specify the size of the artificial valve, and thus it is desired that the annular plane is accurately identified. Furthermore, in a case where the distance from the annular plane to the coronary artery is insufficient, it may be determined that TAVI is not applicable to the patient.

In the method in the Non Patent Literature 1, the center point of an MPR plane is positioned at a characteristic site of the aortic valve and the surrounding of the aortic valve, and, while referring to three orthogonal cross-sections that are perpendicular to each other (the axial plane, the coronal plane, and the sagittal plane serve as the initial planes), the cross-sections (MPR planes) are rotated so as to approach the target planes. In the Non Patent Literature 1, due to the perpendicularity of the three orthogonal cross-sections, that is, the three MPR planes, and the restriction of the point where the three planes of the three orthogonal cross-sections are orthogonal to each other to a single point, the three lowest points of the coronary cusps may not be drawn in the final MPR images. Furthermore, it is difficult to confirm whether the lowest points of the coronary cusps are correctly designated. For example, when the first lowest point of the coronary cusp is set at the center of the three orthogonal cross-sections, in many cases, the other lowest points of the coronary cusps may not be drawn on any of the three orthogonal cross-sections. In addition, for example, when the center of the three orthogonal cross-sections is set at a point considered to be the first lowest point of the coronary cusp, and then the second lowest point of the coronary cusp and the third lowest point of the coronary cusp are designated as the positions of the most upstream sides (lowest points), it may be determined that the first or second lowest point of the coronary cusp is not at the position on the most upstream side (lowest point). In this case, the operation requires skills such as performing adjustment with the second lowest point of the coronary cusp and the third lowest point of the coronary cusp as new centers of the three planes of the three orthogonal cross-sections.

In the following embodiments, a medical image processing apparatus, a medical image processing method, and a storage medium storing a medical image processing program that can improve the accuracy of determining a plane serving as an index in a site in a subject having three or more cusp-shaped structures are described.

### First Embodiment

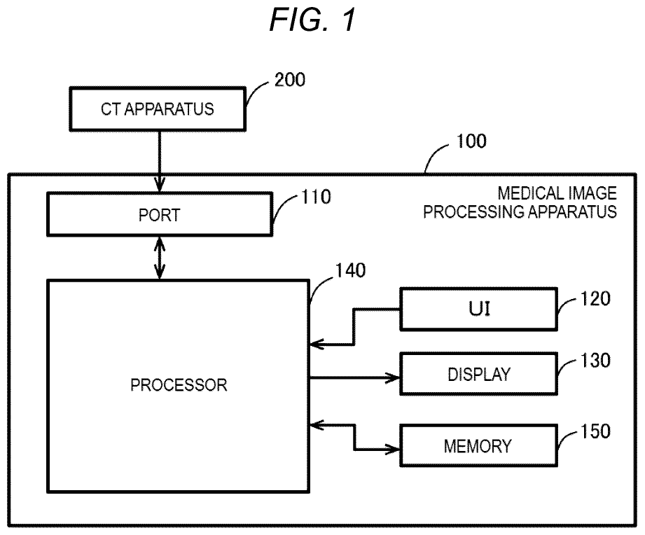

FIG. 1 is a block diagram showing a configuration example of a medical image processing apparatus 100 in a first embodiment. The medical image processing apparatus 100 includes a port 110, a UI 120, a display 130, a processor 140, and a memory 150.

A CT apparatus 200 is connected to the medical image processing apparatus 100. The medical image processing apparatus 100 acquires volume data from the CT apparatus 200 and performs processing on the acquired volume data. The medical image processing apparatus 100 may be configured as a PC and software installed on a PC.

The CT apparatus 200 irradiates the subject with an X-ray and captures an image (CT image) using the difference in X-ray absorption among tissues in the body. The subject may include a living organism, a human body, or an animal. The CT apparatus 200 acquires a sinogram from an X-ray detector and generates a tomographic image (also referred to as a slice image or slice data) of the subject by image reconstruction based on the sinogram. The CT apparatus 200 generates volume data based on the slice data, for example, by stacking the slice data. The slice data and the volume data contain information on an arbitrary area inside the subject. The CT apparatus 200 transmits the volume data to the medical image processing apparatus 100 as the CT image via a wired circuit or a wireless circuit. When capturing the CT image, imaging conditions for CT imaging or imaging conditions for administering a contrast medium may be considered. The imaging may be performed on a digestive organ, a biliary tract, or the like, in addition to blood vessels. The imaging may be performed multiple times at different timing depending on the characteristic of the organ.

The port 110 in the medical image processing apparatus 100 includes a communication port, an external device connection port, a port for connecting to an embedded device, or the like and acquires the volume data obtained from the CT image. The acquired volume data may be immediately sent to the processor 140 to be subjected to various processes or may be stored in the memory 150 and then sent to the processor 140 when necessary to be subjected to various processes. Furthermore, the volume data may be acquired via a storage medium or a recording medium. In addition, the volume data may be acquired in the form of intermediate data, compressed data, sinogram, slice data, or the like. Moreover, the volume data may be acquired from information obtained from a sensor device provided in the medical image processing apparatus 100.

The UI 120 may include a touch panel, a pointing device, a keyboard, or a microphone. The UI 120 receives an arbitrary input operation from a user of the medical image processing apparatus 100. The user may include a doctor, a radiologic technologist, a student, or other healthcare professionals (paramedic staff).

The UI 120 receives various operations. For example, the UI 120 receives an operation of designating a region of interest (ROI), setting a brightness condition (for example, window information), or the like in the volume data or an image based on the volume data (for example, a three-dimensional image or two-dimensional image described later). The region of interest may include regions of various tissues (for example, a blood vessel, a bronchus, an organ, a bone, or brain). The tissue may include a diseased tissue, a normal tissue, a tumor tissue, or the like. The window information includes at least one of a window width (WW) and a window level (WL) and is information for adjusting brightness of the displayed image.

The display 130 may include, for example, an LCD or an organic EL display and displays various information. The various information may include a three-dimensional image or a two-dimensional image obtained from the volume data. The three-dimensional image may include a volume-rendered image, a surface-rendered image, a virtual endoscopic image, a virtual ultrasound image, or the like. The volume-rendered image may include a raysum image, an MIP image, a MinIP image, an average image, a ray-cast image, or the like. The two-dimensional image may include an MPR image, a CPR image, or the like. The MPR image may include an axial image, a sagittal image, a coronal image, or other MPR images.

The memory 150 includes a primary storage such as various ROMs or RAMs. The memory 150 may include a secondary storage such as an HDD or an SSD. The memory 150 may include a tertiary storage such as a USB memory or an SD card. The memory 150 stores various information or programs. The various information may include the volume data acquired by the port 110, the image generated by the processor 140, the setting information set by the processor 140, or various programs. The memory 150 is an example of a non-transient storage medium in which a program is stored.

The processor 140 may include a CPU, a DSP, a GPU, or the like. The processor 140 may be configured of various integrated circuits (for example, LSI or an FPGA). The processor 140 functions as a processing portion 160 that performs various processes or controls by executing a medical image processing program stored in the memory 150.

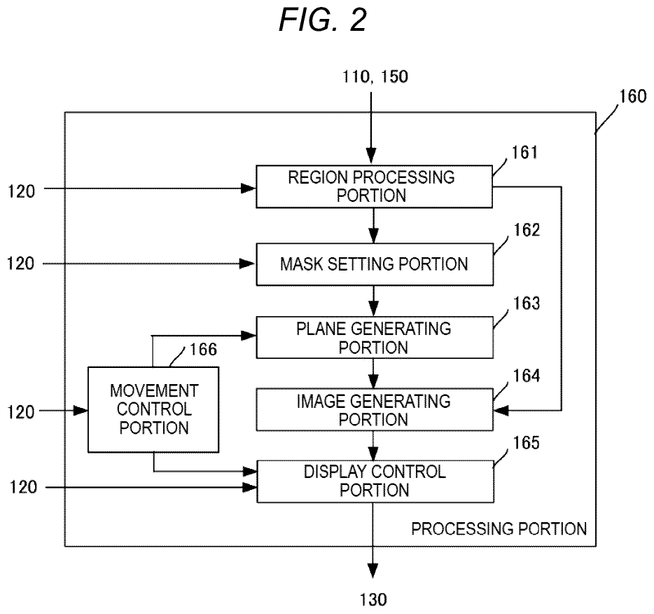

FIG. 2 is a block diagram showing a functional configuration example of the processing portion 160.

The processing portion 160 includes a region processing portion 161, a mask setting portion 162, a plane generating portion 163, an image generating portion 164, a display control portion 165, and a movement control portion 166. The processing portion 160 supervises various processes or controls of the medical image processing apparatus 100. The portions included in the processing portion 160 may each be realized by one type of hardware as different functions or may be realized by multiple types of hardware as different functions. Furthermore, each portion included in the processing portion 160 may be realized by a dedicated hardware part.

The region processing portion 161 acquires the volume data of the subject via, for example, the port 110. The region processing portion 161 extracts an arbitrary region contained in the volume data. The region processing portion 161 may automatically designate the region of interest based on, for example, the voxel value of the volume data and extract the region of interest. The region processing portion 161 may manually designate the region of interest via, for example, the UI 120 and extract the region of interest. In the present embodiment, the region of interest includes, for example, the heart or a tubular tissue (for example, the aorta or the coronary artery).

The mask setting portion 162 sets a mask onto which an image is drawn in volume rendering. The mask setting portion 162 sets an arbitrary region in the volume data as a mask region. When the mask is used, the voxels of the mask region are drawn in the image, and the voxels of the non-mask region outside the mask region are not drawn in the image. The mask region may be a region obtained by performing segmentation in the region extracted by the region processing portion 161 or may be a region not extracted by the region processing portion 161. In addition, a plurality of mask regions may be set for each region extracted by the region processing portion 161. The mask setting portion 162 may automatically extract the mask region by a known method or manually extract the mask region by the input operation performed by the user via the UI 120.

The plane generating portion 163 generates (sets) an arbitrary plane in the volume data. The plane generating portion 163 generates an annular plane SA. For example, the plane generating portion 163 designates the three lowest points of the coronary cusps and generates the annular plane SA containing the designated three lowest points of the coronary cusps. In other words, the annular plane SA is a plane containing a lowest point N1 of NCC, a lowest point R1 of RCC, and a lowest point L1 of LCC. The annular plane SA may include a virtual annular plane obtained before the annular plane SA is finally defined (determined). The virtual annular plane may include an annular plane generated by the method in the Non Patent Literature 1, an annular plane generated using a mask, or the like.

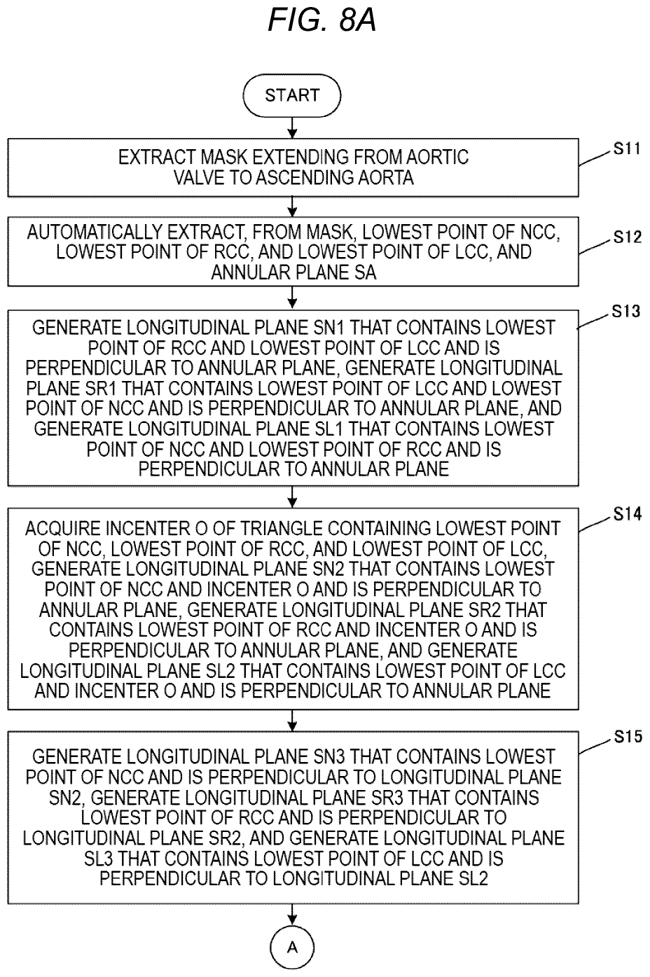

The plane generating portion 163 generates a longitudinal plane SF that is a plane that passes through one or two lowest points of the coronary cusps among the three lowest points of the coronary cusps and is perpendicular to the annular plane SA. The longitudinal plane SF includes, for example, a longitudinal plane SN1, SL1, SR1, SN2, SL2, SR2, SN3, SL3, or SR3 described later. For example, the plane generating portion 163 may generate the longitudinal plane SNI that contains (passes through) the lowest point R1 of RCC and the lowest point L1 of LCC. The plane generating portion 163 may generate the longitudinal plane SR1 that contains the lowest point L1 of LCC and the lowest point N1 of NCC. The plane generating portion 163 may generate the longitudinal plane SL1 that contains the lowest point N1 of NCC and the lowest point R1 of RCC. The plane generating portion 163 may generate the longitudinal plane SN2 that contains the lowest point N1 of NCC and an incenter O of a triangle TR. The triangle TR is a triangle obtained by connecting the lowest point R1 of RCC, the lowest point L1 of LCC, and the lowest point N1 of NCC as the vertices (refer to FIG. 7). The triangle TR is present on the annular plane SA. The plane generating portion 163 may generate the longitudinal plane SR2 that contains the lowest point R1 of RCC and the incenter O of the triangle TR. The plane generating portion 163 may generate the longitudinal plane SL2 that contains the lowest point L1 of LCC and the incenter O of the triangle TR. The plane generating portion 163 may generate the longitudinal plane SN3 that contains the lowest point N1 of NCC and is perpendicular to the longitudinal plane SN2. The plane generating portion 163 may generate the longitudinal plane SR3 that contains the lowest point R1 of RCC and is perpendicular to the longitudinal plane SR2. The plane generating portion 163 may generate the longitudinal plane SN3 that contains the lowest point L1 of LCC and is perpendicular to the longitudinal plane SN2. The above longitudinal planes may be planar MPR planes or curved CPR planes.

The image generating portion 164 generates various images. The image generating portion 164 generates a three-dimensional image, a two-dimensional image, or a tomographic image based on at least a portion of the acquired volume data (for example, the volume data of the extracted region). The image generating portion 164 may generate an image by performing various types of rendering (for example, volume rendering or surface rendering).

The image generating portion 164 generates an MPR image by visualizing an MPR plane based on, for example, the volume data (voxels) located on the MPR plane. The MPR image is an image obtained by, for example, visualizing the annular plane SA or the longitudinal plane SF. The image generating portion 164 generates a CPR image by visualizing a CPR plane based on, for example, the volume data (voxels) located on the CPR plane. The CPR image is an image obtained by, for example, visualizing the annular plane SA or the longitudinal plane SF.

The display control portion 165 displays various data, information, or images on the display 130. The images are images obtained by visualizing a portion of tissues in the subject and may include, for example, an image generated by the image generating portion 164, a cross-sectional image (for example, an MPR image or a CPR image) of a predetermined cross-section (for example, an MPR plane or a CPR plane), and a tomographic image of a predetermined cross-section.

The movement control portion 166 moves an arbitrary point or plane in the volume data. The movement control portion 166 may move the arbitrary point or plane by an input operation of the user via the UI 120 or move the arbitrary point or plane in conjunction with the movement of a point or plane that is different from the arbitrary point or plane. The arbitrary point may include the three lowest points of the coronary cusps. The arbitrary plane may include the annular plane SA or the longitudinal plane SF.

Although a case in which the annular plane SA or the longitudinal plane SF is an MPR plane is mainly illustrated in the present embodiment, the present disclosure can also be applied to CPR planes. Furthermore, although a case in which the image obtained by visualizing the annular plane SA or the longitudinal plane SF is an MPR image is mainly illustrated, the present disclosure can also be applied to CPR images.

Next, an example of generating the annular plane SA will be described.

The medical image processing apparatus 100 provides UI for identifying virtually set annulus AR and annular plane SA (virtual annular plane) by manual adjustment and finally sets the annulus AR and the annular plane SA. The processing portion 160 displays a plurality of longitudinal planes SF that pass through virtually set lowest points of the coronary cusps and are perpendicular to the annular plane SA. In this case, the direction of each longitudinal plane SF is determined based on the three lowest points of the coronary cusps, and thus the longitudinal planes SF are not restricted to being in a perpendicular relationship with each other, such as the relationship among the axial plane, the coronal plane, and the sagittal plane. Therefore, the processing portion 160 can easily adjust the positions of the lowest points of the coronary cusps without taking the positional relationship among the longitudinal planes SF into account, whereby the annular plane SA or the longitudinal planes SF can be easily adjusted. For example, the processing portion 160 can easily adjust the positions or directions of the lowest points of the coronary cusps, the annular plane SA, or the longitudinal planes SF by designating and moving, by clicking, dragging, or the like, the lowest point of the coronary cusp within the MPR plane of each of the annular plane SA and longitudinal planes SF. For example, the processing portion 160 may recalculate the annular plane SA and the longitudinal planes SF and redisplay the MPR images of the annular plane SA and the longitudinal planes SF each time the lowest point of the coronary cusp moves. The processing portion 160 may move the lowest points of the coronary cusps, the annular plane SA, or the longitudinal planes SF via the UI 120.

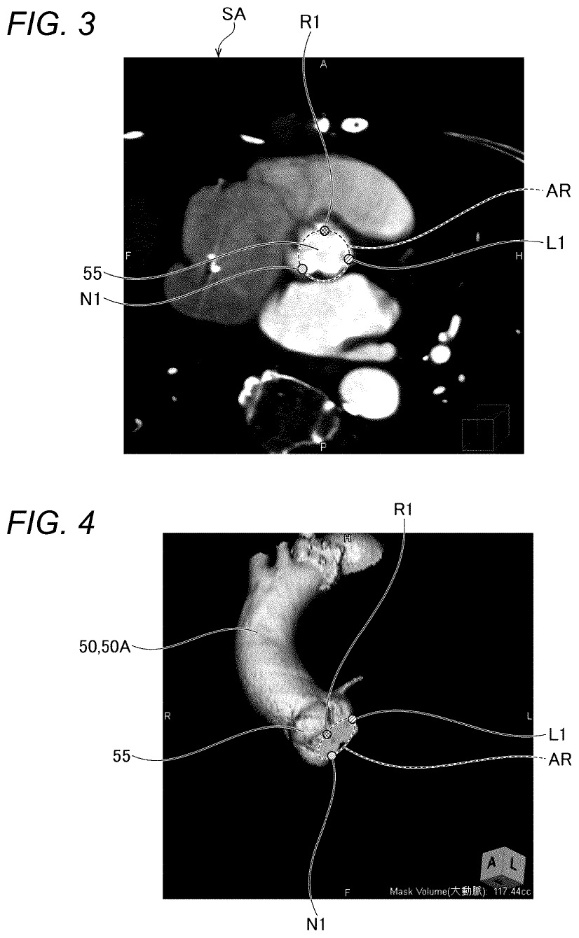

FIG. 3 is a diagram showing an example of the annular plane SA containing the three lowest points of the coronary cusps of an aortic valve 55.

In FIG. 3, the MPR image in the annular plane SA is displayed. In addition, the annulus AR connecting the three lowest points of the coronary cusps is indicated in FIG. 3. The three lowest points of the coronary cusps and the annular plane SA in FIG. 3 are set by, for example, the method in the Non Patent Literature 1, but the accuracy of the method is insufficient.

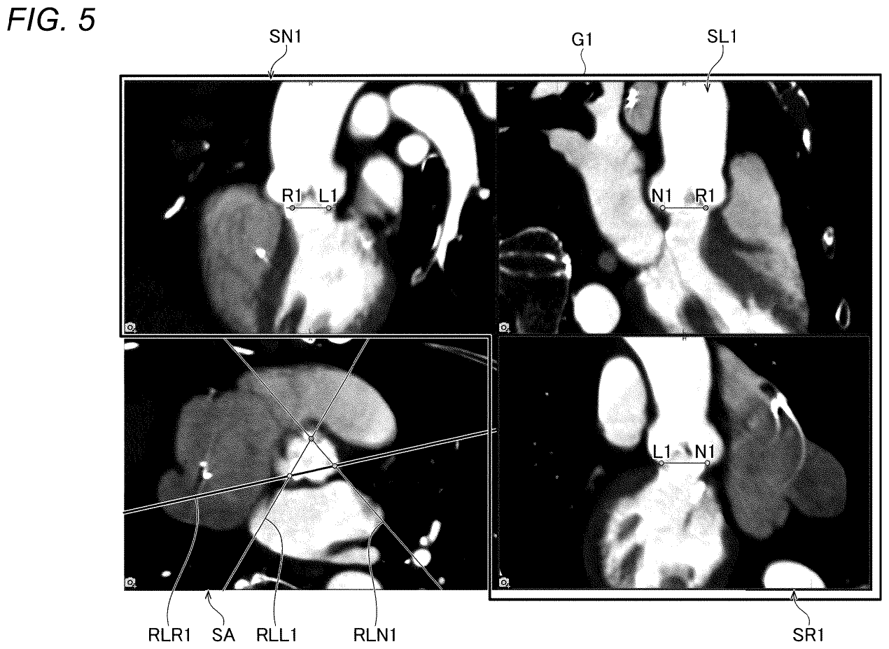

FIG. 4 is a diagram showing an example of the annular plane SA based on mask setting.

In FIG. 4, the mask setting portion 162 extracts an ascending aorta 50A from the region of an aorta 50 using mask setting. FIG. 4 shows a volume-rendered image containing the ascending aorta 50A, the aortic valve 55, and the three lowest points of the coronary cusps. The mask setting portion 162 can set the annular plane SA by searching for the plane of the ascending aorta 50A that contacts the mask. In addition, the annulus AR connecting the three lowest points of the coronary cusps is indicated in FIG. 4. The accuracy of extracting the annular plane SA is insufficient in the extraction of the ascending aorta 50A using the mask. This is because the mask of the ascending aorta 50A is influenced by, for example, the threshold of the CT value that has been set, and NCC, RCC, and LCC are not always clearly visualized.

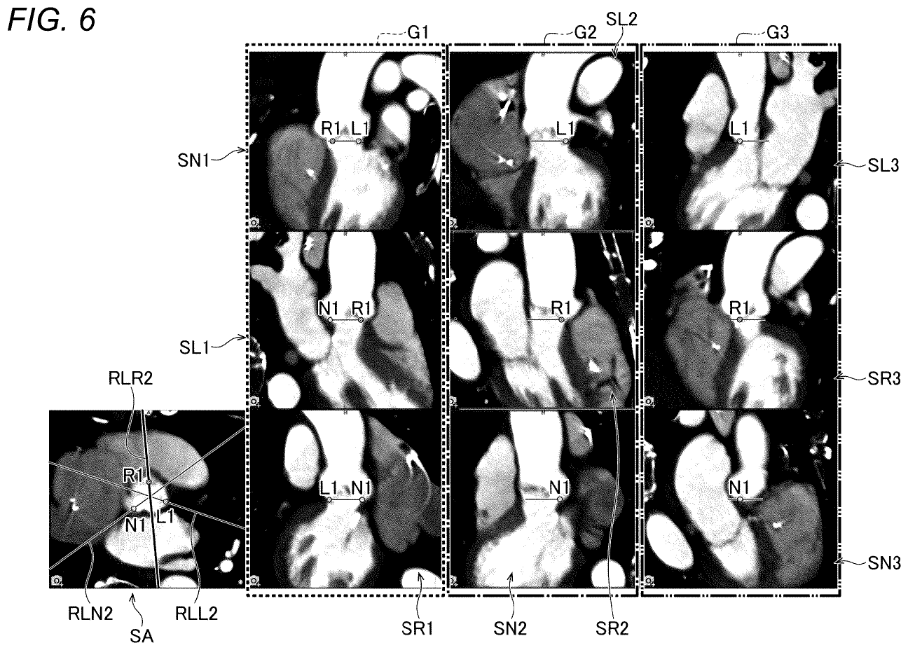

FIG. 5 is a diagram showing an example of a case where the annular plane SA and three longitudinal planes SF are simultaneously displayed on the display 130.

Each of the three longitudinal planes SF in FIG. 5 is perpendicular to the annular plane SA and contains two different lowest points of the coronary cusps among the three lowest points of the coronary cusps. Specifically, the longitudinal plane SN1 contains the lowest point L1 of LCC and the lowest point R1 of RCC, as shown in FIG. 5. The longitudinal plane SL1 contains the lowest point R1 of RCC and the lowest point N1 of NCC. The longitudinal plane SR1 contains the lowest point N1 of NCC and the lowest point L1 of LCC.

The user performs a movement operation on, for example, the lowest point of the coronary cusp contained in any of the longitudinal planes SF, via the UI 120. The processing portion 160 receives the operation of inputting the movement operation via the UI 120 and updates the position of the lowest point of the coronary cusp according to the movement operation, thereby updating the annular plane SA. In this manner, the annular plane SA is gradually updated by the medical image processing apparatus 100 to become optimal. Furthermore, the results of the update can be displayed as a list of MPR images of the annular plane SA and the three longitudinal planes SF as shown in FIG. 5, and the user can confirm and compare a total of four MPR images.

Although the longitudinal plane SR1 is focused on in FIG. 5, the focusing may not be performed. In addition, the thicknesses of reference lines RLN1, RLL1, and RLR1 may be the same.

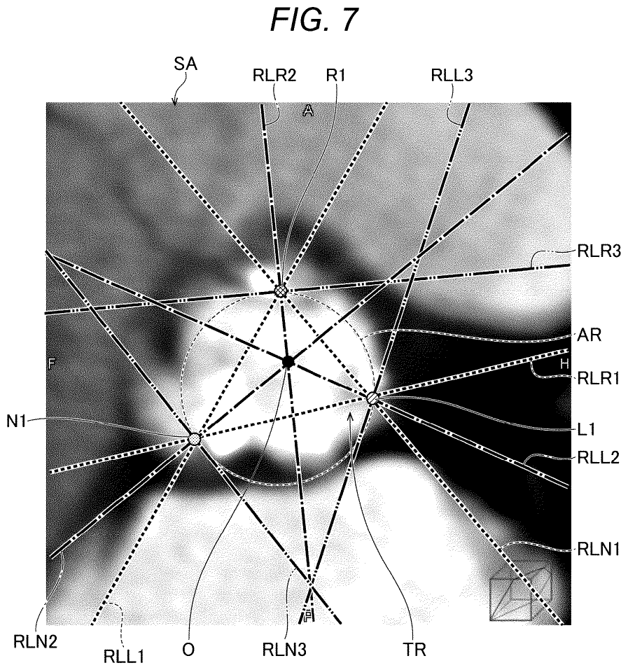

FIG. 6 is a diagram showing an example of the annular plane SA and the nine longitudinal planes SF.

Since the longitudinal planes SF are perpendicular to the annular plane SA and contain at least one of the three lowest points of the coronary cusps, there are an infinite number of the longitudinal planes SF. Among the longitudinal planes, there are three longitudinal planes that contain two different lowest points of the coronary cusps among the three lowest points of the coronary cusps (refer to FIG. 5). For example, the intersection points between the longitudinal planes SF and the annular plane SA are indicated as straight lines on the annular plane SA.

Furthermore, in FIG. 6, the nine longitudinal planes SF are divided into a first group G1, a second group G2, and a third group G3. The first group G1 is a group to which the three longitudinal planes SF that contain two different lowest points of the coronary cusps among the three lowest points of the coronary cusps belong. The first group G1 includes the longitudinal planes SN1, SL1, and SR1.

The second group G2 is a group to which three longitudinal planes SF that contain one lowest point of the coronary cusp among the three lowest points of the coronary cusps and the incenter O of the triangle TR of which the vertices are the three lowest points of the coronary cusps belong. That is, each of the three longitudinal planes SF belonging to the second group G2 contains each of the three lowest points of the coronary cusps and the incenter O of the triangle TR consisting of the three lowest points. The second group G2 includes the longitudinal planes SN2, SL2, and SR2.

The third group G3 is a group to which three longitudinal planes SF that contain one lowest point of the coronary cusp among the three lowest points of the coronary cusps and are perpendicular to the longitudinal planes containing the one lowest point of the coronary cusp and the incenter O (that is, the longitudinal planes SF of the second group G2) belong. That is, each of the three longitudinal planes SF belonging to the third group G3 is a longitudinal plane that passes through each of the three lowest points of the coronary cusps and is perpendicular to a straight line passing through the incenter O of the triangle TR. The third group G3 includes the longitudinal planes SN3, SL3, and SR3.

The second group G2 is provided with the longitudinal planes SF containing the lowest points of the coronary cusps and the incenter O. That is, the longitudinal planes SF included in the second group G2 are located at the positions where the angles formed by two longitudinal planes included in the first group Gl are bisected (refer to FIG. 7). Similarly, the longitudinal planes SF included in the third group G3 are located at the positions where the angles formed by two longitudinal planes included in the first group G1 are bisected (refer to FIG. 7). Therefore, the possibility that the lowest point of the coronary cusp is included in the positions of the longitudinal planes SF of the second group G2 and the third group G3 increases even in a case where the lowest point of the coronary cusp is not present at the positions of the longitudinal planes SF of the first group G1. Such increase in the possibility is attributable to even arrangement of each of the longitudinal planes SF included in the second group G2 and the third group G3 at the positions where the angles formed by two longitudinal planes included in the first group G1 are bisected. Therefore, the medical image processing apparatus 100 easily finds the lowest point of the coronary cusp in any of the longitudinal planes SF and easily confirms that the lowest points of the coronary cusps drawn in the longitudinal planes SF are true lowest points of the coronary cusps, whereby the accuracy of determining the annular plane SA can be improved.

The user performs a movement operation on, for example, the lowest point of the coronary cusp contained in any of the longitudinal planes SF, via the UI 120. The processing portion 160 receives the operation of inputting the movement operation via the UI 120 and updates the position of the lowest point of the coronary cusp according to the movement operation, thereby updating the annular plane SA. In this manner, the annular plane SA is gradually updated by the medical image processing apparatus 100 to become optimal. Furthermore, the results of the update can be displayed as a list of the MPR images of the annular plane SA and the nine longitudinal planes SF as shown in FIG. 6, and the user can confirm a total of ten MPR images while comparing the images.

Here, a case in which the number of the longitudinal planes is nine has been illustrated, but the present disclosure is not limited thereto. For example, finding the lowest points of the coronary cusps becomes easier when ten or more longitudinal planes are prepared. Furthermore, although a case is illustrated in which the nine longitudinal planes are arranged at equal angles so that it is easy to search for the region in the longitudinal planes of the first group G1 that cannot be reached, the present disclosure is not limited thereto. The angles that the longitudinal planes form with each other may not be equal.

Although the longitudinal plane SR2 is focused on in FIG. 6, the focusing may not be performed. In addition, the thicknesses of reference lines RLN2, RLL2, and RLR2 may be the same. Moreover, although reference lines RL other than the three reference lines are not indicated in FIG. 6, such reference lines RL may also be drawn.

FIG. 7 is a diagram showing an example of the reference lines RL indicated on the annular plane SA.

The positions of the various longitudinal planes SF perpendicular to the annular plane SA are indicated as the reference lines RL in the annular plane SA as, for example, straight lines. The reference lines RL include reference lines RLN1, RLR1, RLL1, RLN2, RLR2, RLL2, RLN3, RLR3, and RLL3. The reference line RLN1 represents the intersection line between the annular plane SA and the longitudinal plane SN1. The reference line RLR1 represents the intersection line between the annular plane SA and the longitudinal plane SR1. The reference line RLL1 represents the intersection line between the annular plane SA and the longitudinal plane SL1. The reference line RLN2 represents the intersection line between the annular plane SA and the longitudinal plane SN2. The reference line RLR2 represents the intersection line between the annular plane SA and the longitudinal plane SR2. The reference line RLL2 represents the intersection line between the annular plane SA and the longitudinal plane SL2. The reference line RLN3 represents the intersection line between the annular plane SA and the longitudinal plane SN3. The reference line RLR3 represents the intersection line between the annular plane SA and the longitudinal plane SR3. The reference line RLL3 represents the intersection line between the annular plane SA and the longitudinal plane SL3.

The display control portion 165 may draw all reference lines RL on the annular plane SA or draw only some of the reference lines RL, omitting the drawing of some of the reference lines RL. For example, when one of the longitudinal planes SF of the first group G1 is focused on, only the reference lines for the first group G1 may be drawn on the annular plane SA, and the rest of the reference lines may not be drawn. For example, when one of the longitudinal planes SF of the second group G2 is focused on, only the reference lines for the second group G2 may be drawn on the annular plane SA, and the rest of the reference lines may not be drawn.

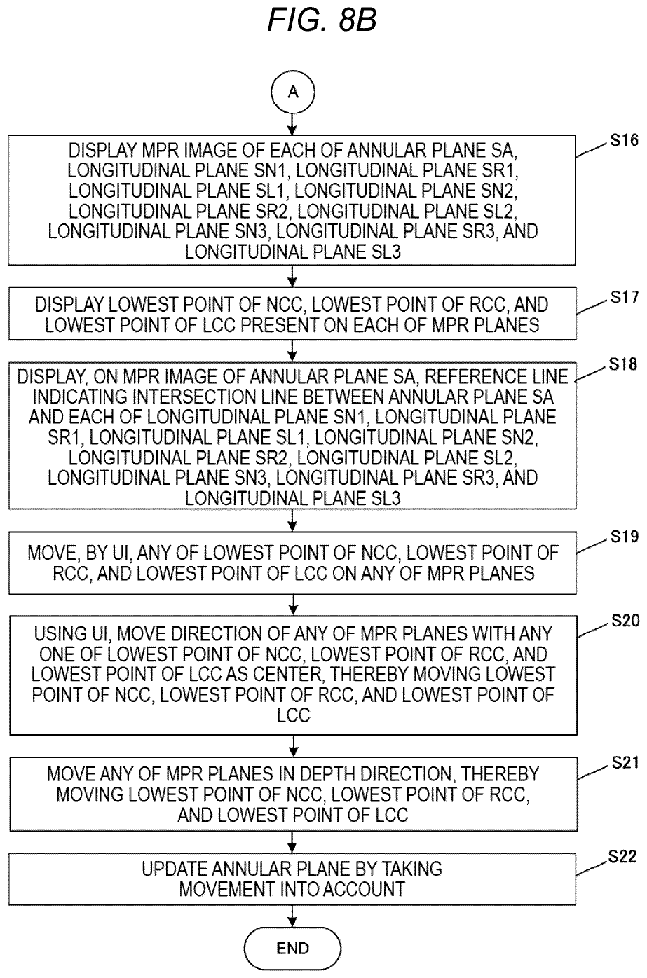

FIGS. 8A and 8B are flow charts showing an operation example of the medical image processing apparatus 100.

First, the region processing portion 161 acquires volume data of the subject and extracts the region of the aorta 50 from the volume data. The mask setting portion 162 sets the region extending from the aortic valve to the ascending aorta in the region of the aorta 50 as a mask region and extracts the mask region (S11).

The plane generating portion 163 extracts the lowest point Nl of NCC, the lowest point R1 of RCC, and the lowest point L1 of LCC in the mask region and generates (sets) the annular plane SA containing the lowest point N1 of NCC, the lowest point R1 of RCC, and the lowest point L1 of LCC (S12). This annular plane SA is an initial annular plane which is a virtual annular plane. Therefore, the accuracy may be low. The virtual annular plane may be generated by manually determining lowest point N1 of NCC, the lowest point R1 of RCC, and the lowest point L1 of LCC by the method in the Non Patent Literature 1, instead of generating the virtual annular plane using the mask.

The plane generating portion 163 generates (sets) the three longitudinal planes SN1, SR1, and SL1 of the first group G1 (S13). The plane generating portion 163 acquires the incenter O of the triangle TR and generates (sets) the three longitudinal planes SN2, SR2, and SL2 of the second group G2 (S14). The three longitudinal planes SN3, SR3, and SL3 of the third group G3 are generated (set) (S15).

The image generating portion 164 generates the MPR images of MPR planes, the MPR planes being the annular plane SA and the nine longitudinal planes SF that have been generated. Specifically, the MPR images of the annular plane SA and the nine longitudinal planes SN1, SR1, SL1, SN2, SR2, SL2, SN3, SR3, and SL3 are generated. The display control portion 165 displays the MPR images of the annular plane SA and the nine longitudinal planes SN1, SR1, SL1, SN2, SR2, SL2, SN3, SR3, and SL3 on the display 130 (S16).

The display control portion 165 displays the MPR image of the annular plane SA along with the lowest point N1 of NCC, the lowest point R1 of RCC, and the lowest point L1 of LCC, which are the three lowest points of the coronary cusps located in the annular plane SA. In addition, the display control portion 165 displays each of the MPR images of the nine longitudinal planes SF along with the lowest point of the coronary cusp present on each of the longitudinal planes SF (that is, one or two lowest points of the coronary cusps) among the lowest point N1 of NCC, the lowest point R1 of RCC, and the lowest point L1 of LCC (S17).

The display control portion 165 draws, on the MPR image of the annular plane SA, the reference line RL as the intersection line between the annular plane SA and each of the nine longitudinal planes SF (S18). Specifically, the reference line RLN1 is drawn as the intersection line between the annular plane SA and the longitudinal plane SN1. The reference line RLR1 is drawn as the intersection line between the annular plane SA and the longitudinal plane SR1. The reference line RLL1 is drawn as the intersection line between the annular plane SA and the longitudinal plane SL1. The reference line RLN2 is drawn as the intersection line between the annular plane SA and the longitudinal plane SN2. The reference line RLR2 is drawn as the intersection line between the annular plane SA and the longitudinal plane SR2. The reference line RLL2 is drawn as the intersection line between the annular plane SA and the longitudinal plane SL2. The reference line RLN3 is drawn as the intersection line between the annular plane SA and the longitudinal plane SN3. The reference line RLR3 is drawn as the intersection line between the annular plane SA and the longitudinal plane SR3. The reference line RLL3 is drawn as the intersection line between the annular plane SA and the longitudinal plane SL3.

By viewing the display 130, the user confirms the display of the MPR images of the annular plane SA and each of the longitudinal planes SF and the lowest points of the coronary cusps on the MPR images. At the stage of the annular plane SA, the position of the lowest point of the coronary cusp may not be the actual lowest point. The lowest point of the coronary cusp represents the boundary between one of the coronary cusps of the aortic valve (NCC, RCC, or LCC) and the heart (especially the left ventricle) and represents the end point on the most upstream side of the coronary cusp. When the position of the lowest point of the coronary cusp is not the actual lowest point, in many cases, the position designated as the lowest point of the coronary cusp is displaced away from the inner side of the coronary cusp, that is, the heart (for example, the left ventricle). It is determined that the positions of the lowest points of the coronary cusps are not the actual lowest points of the coronary cusps, for example, when the positions slightly above the lowest points are the lowest points of the coronary cusps in the MPR images of the longitudinal planes SF in FIG. 5 or 6, or when the cusps of the coronary cusps are visible in the MPR image of the annular plane SA. When the lowest points of the coronary cusps coincide with the positions of the actual lowest points, the MPR image of the annular plane SA is displayed in a state where the cusps of the coronary cusps are invisible, and thus the lowest points are visible to the user.

When the user determines that the position of the lowest point of the coronary cusp is not the lowest point of the coronary cusp (NCC, RCC, or LCC), the position of the lowest point of the coronary cusp can be manually moved using the UI 120.

For example, using the UI 120, the user may move at least one of the lowest point N1 of NCC, the lowest point R1 of RCC, and the lowest point L1 of LCC in at least one of the annular plane SA and each of the longitudinal planes SF. In this case, the movement control portion 166 may receive an input operation of moving at least one of the lowest point N1 of NCC, the lowest point R1 of RCC, and the lowest point L1 of LCC in at least one of the annular plane SA and each of the longitudinal planes SF from the user via the UI 120. The movement control portion 166 moves at least one of the lowest point N1 of NCC, the lowest point R1 of RCC, and the lowest point L1 of LCC in at least one of the annular plane SA and each of the longitudinal planes SF according to the input operation (S19).

Furthermore, with any one of the lowest point N1 of NCC, the lowest point R1 of RCC, and the lowest point L1 of LCC in at least one of the annular plane SA and each of the longitudinal planes SF as the center point, the plane containing the center point may be moved in a rotating manner by the user using the UI 120. At this time, the movement of the plane is the movement of tilting the plane with the center point as the center. In this case, the movement control portion 166 may receive, from the user via the UI 120, an input operation of moving the plane containing the center point, which is any one of the lowest point Nl of NCC, the lowest point R1 of RCC, and the lowest point L1 of LCC in at least one of the annular plane SA and each of the longitudinal planes SF. The movement control portion 166 moves the plane containing the center point, which is any one of the lowest point N1 of NCC, the lowest point R1 of RCC, and the lowest point L1 of LCC in at least one of the annular plane SA and each of the longitudinal planes SF, according to the input operation (S20). The movement control portion 166 moves at least one of the lowest point N1 of NCC, the lowest point R1 of RCC, and the lowest point L1 of LCC present on the plane in conjunction with the movement of the plane.

Furthermore, the user may perform, using the UI 120, parallel movement on at least one of the annular plane SA and each of the longitudinal planes SF in the direction (that is, the depth direction or the forward direction) perpendicular to an MPR plane (that is, at least one of the annular plane SA and each of the longitudinal planes SF). In this case, the movement control portion 166 may receive an input operation of performing the parallel movement on at least one of the annular plane SA and each of the longitudinal planes SF in a direction perpendicular to the MPR plane from the user via the UI 120. The movement control portion 166 performs the parallel movement on at least one of the annular plane SA and each of the longitudinal planes SF in a direction perpendicular to the MPR plane according to the input operation (S21). The movement control portion 166 moves at least one of the lowest point N1 of NCC, the lowest point R1 of RCC, and the lowest point L1 of LCC present on the plane in conjunction with the movement of the plane. The movement control portion 166 may set at least one of the lowest point N1 of NCC, the lowest point R1 of RCC, and the lowest point L1 of LCC present on the plane as a candidate for the movement in conjunction with the movement of the plane and perform the movement in response to a confirmation operation received from the user.

The plane generating portion 163 generates (updates) the annular plane SA containing the lowest point N1 of NCC, the lowest point RI of RCC, and the lowest point L1 of LCC by taking into account the movement performed by Steps S19 to S21 (S22). At least one of Steps S19 to S21 may be performed.

Also, the display control portion 165 may update the MPR image of the MPR plane of at least one of the annular plane SA and each of the longitudinal planes SF by taking into account the lowest point of the coronary cusp or the plane that has been moved. For example, the display control portion 165 may update the display of a total of four planes, the annular plane SA and three longitudinal planes SN1, SR1, and SL1 or update the display of a total of ten planes, the annular plane SA and nine longitudinal planes SN1, SR1, SL1, SN2, SR2, SL2, SN3, SR3, and SL3, in accordance with the movement of one of the lowest points of the coronary cusps.

Also, the display control portion 165 may update the drawing of at least one reference line RL which represents the position of the MPR plane of at least one of the longitudinal planes SF on the annular plane SA by taking into account the lowest point of the coronary cusp or the plane that has been moved. For example, in a case where the longitudinal plane SF is subjected to parallel movement in the depth direction, the reference line RL which represents the intersection line between the annular plane SA and the longitudinal plane SF is subjected to the parallel movement.

As a result, the medical image processing apparatus 100 can determine the position of each lowest point of the coronary cusp with higher accuracy than in the initial stage of the annular plane SA (for example, the virtual annular plane acquired in Step S11). Therefore, the processing portion 160 can generate the annular plane SA containing the three lowest points of the coronary cusps with high accuracy. Thus, the processing portion 160 can derive (for example, calculate) the perimeter or diameter of the annulus with high accuracy based on the annular plane SA. Therefore, the medical image processing apparatus 100 can suitably determine the size of the expensive artificial valve that replaces the aortic valve of the subject (for example, a patient), can suitably determine the applicability of TAVI, and can improve the safety in the patient subjected to TAVI.

In the medical image processing apparatus 100, the processing portion 160 may separately determine suitability of the annular plane SA generated by Step S22. In this case, the processing portion 160 repeatedly executes Steps S13 to S18 after Step S22.

By viewing the display 130 again, the user confirms the display of the MPR images of the annular plane SA and each of the longitudinal planes SF and the lowest points of the coronary cusps on the MPR images. Using the UI 120, the user instructs the execution of at least one of Steps S19 to S21 as necessary. The processing portion 160 receives an input operation of instructing the execution of at least one of Steps S19 to S21 from the user via the UI 120 and executes at least one of Steps S19 to S21 as necessary. Then, the processing portion 160 generates (updates once again) the annular plane SA in Step S22. In this manner, the medical image processing apparatus 100 may repeatedly execute at least a part of the processes in FIGS. 8A and 8B until the annular plane SA suitable for the user is obtained.

In this manner, the medical image processing apparatus 100 of the present embodiment can increase the accuracy of the annular plane SA by adjusting the position of the lowest point of the coronary cusp or a plane using the UI 120. Furthermore, the user instructs the movement of the point or the plane while confirming the MPR image of the annular plane SA or the longitudinal plane SF, and the result thereof can be confirmed from the display of the result. Therefore, it is possible to confirm that the display of the annular plane or each of the longitudinal planes SF has been updated by, for example, moving one of the lowest points of the coronary cusps. Therefore, the movement operation can be executed while sequentially confirming whether the movement of one of the lowest points of the coronary cusps has caused the other lowest points of the coronary cusps to be displaced from the lowest points or the like.

In addition, in the case of adjusting the direction of a plane under the condition in which three orthogonal cross-sections are perpendicular to each other, it has been conventionally necessary to perform an input operation on a plane that is different from the plane that the user focuses on to rotate the plane. On the other hand, the medical image processing apparatus 100 can simply adjust the direction of the longitudinal plane SF, since the operation of moving the lowest point of the coronary cusp is performed in conjunction with the adjustment of the angle of the longitudinal plane SF.

Furthermore, the medical image processing apparatus 100 can suitably determine the annular plane SA, since all of the three lowest points of the coronary cusps can be suitably determined. Therefore, the medical image processing apparatus 100 can improve the accuracy of measuring the perimeter or diameter of the annular plane SA and can suitably determine the size of the artificial valve. The medical image processing apparatus 100 can therefore prevent the coronary artery arising near the aortic valve from being obstructed by the artificial valve. The medical image processing apparatus 100 can also prevent the artificial valve from falling off due to the size of the artificial valve being small.

### Modification Examples of First Embodiment

In the first embodiment, a case of generating three or nine MPR images of the longitudinal planes is illustrated, but the present disclosure is not limited thereto. The number of the MPR images of the longitudinal planes generated may be any number as long as at least two of the MPR images are generated. In this case, at least two longitudinal planes SF among the nine longitudinal planes SF need to be generated by the plane generating portion 163 so as to minimize the number of the longitudinal planes SF. In this case, each of the two longitudinal planes contains one or two lowest points of coronary cusps, and all of the three lowest points of the coronary cusps are included in the two longitudinal planes. Thus, user can confirm, from the display on the display 130, whether or not the three lowest points of the coronary cusps has been displaced, and the medical image processing apparatus 100 can accurately determine the annular plane SA.

In the first embodiment, the movement control portion 166 may perform the parallel movement on the annular plane SA or each of the longitudinal planes SF in the direction perpendicular to a plane (MPR plane), that is, in the depth direction or the forward direction. In this case, the movement control portion 166 may move the lowest point of the coronary cusp on at least one of the annular plane SA and each of the longitudinal planes SF in conjunction with the movement of the plane, thereby updating the position of the lowest point of the coronary cusp. Furthermore, the movement control portion 166 may designate and move the lowest point of a coronary cusp on the plane that has been moved so as to further update the position of the lowest point of the coronary cusp.

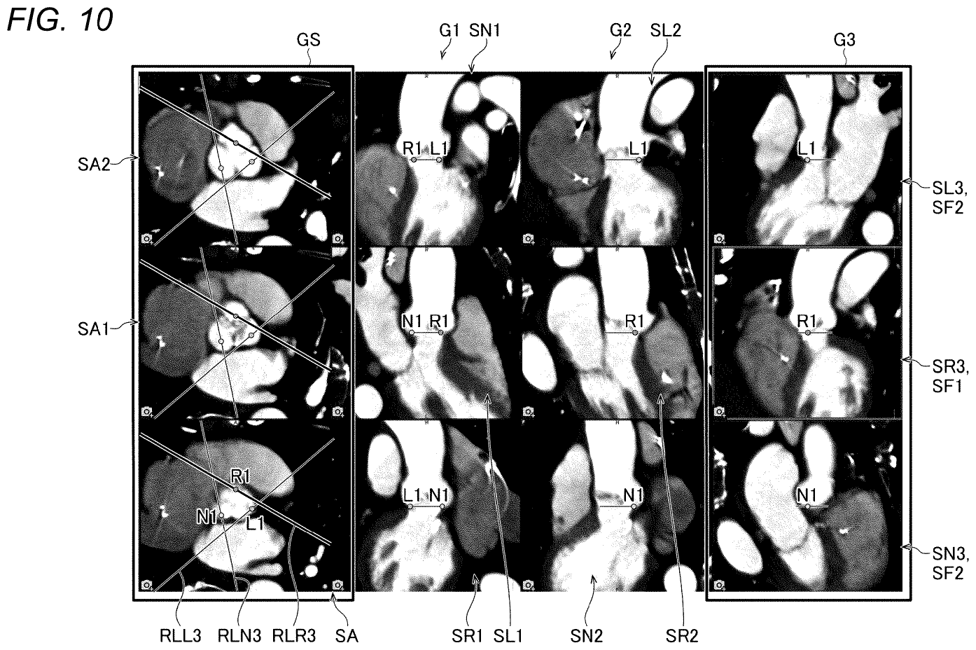

The display control portion 165 may also display, along with the MPR image of the annular plane, the MPR image of an offset annular plane which is a plane obtained by subjecting the annular plane to parallel movement in the depth direction (refer to FIG. 10 of a second embodiment described later). By displaying the MPR image of the offset annular plane as well, the position of the annular plane can be more easily found by the user. Furthermore, the user can confirm what is present in the vicinity of the annular plane SA and confirm whether the lowest points of the coronary cusps are actually present at the position of the annular plane SA (whether the lowest points of the coronary cusps are present at the position of the offset annular plane). A case where the lowest points of the coronary cusps are not present at the position of the annular plane can be visually recognized by the appearance of the cusp.

In the first embodiment, a case is illustrated in which the aortic valve is illustrated as an example of the cusp-shaped structures, and the lowest points of the coronary cusps are moved, but the present disclosure is not limited thereto. For example, the cusp-shaped structures may be a tricuspid valve, a pulmonary valve, a venous valve, or other cusp-shaped structures, and the present disclosure may be applied to the movement or drawing of the lowest points of the cusp-shaped structures, the generation, movement, or drawing of a plane connecting the lowest points of the cusp-shaped structures, or the like.

In the first embodiment, the longitudinal planes are described as planes perpendicular to the annular plane SA which contains the lowest points of the coronary cusps, but the present disclosure is not limited thereto. In other words, as for these planes, it is not essential that the direction perpendicular to the annular plane SA is longer than the direction along the annular plane SA, and the planes may be transverse planes of which the direction perpendicular to the annular plane is shorter than the direction along the annular plane. In either case, the planes are perpendicular to the annular plane.

The medical image processing apparatus 100 may perform a combination of the modification examples described above.

### Details of Achieving Second Embodiment of Present Disclosure

In the method in the Non Patent Literature 1, the derivation of the annular plane is attempted using the axial plane, the coronal plane, and the sagittal plane as the three perpendicular cross-sections. In this case, a reference line is drawn on the MPR plane of one cross-section, the reference line representing the positions of the other two cross-sections.

Here, the operation is performed by the user in a state in which a plurality of (for example, three or more) MPR images obtained by visualizing the MPR planes are displayed together, by performing an input operation on the MPR images on the screen using the UI. Conventionally, there were cases in which the medical image processing apparatus drew, on one MPR image, the reference lines representing the positions of the MPR planes of other MPR images as described above, but it was difficult to determine, on one MPR image, which MPR image is to be used among the other MPR images to perform the operation.

In the second embodiment, a medical image processing apparatus, a medical image processing method, and a storage medium storing a medical image processing program are described, which facilitate determining, on one cross-sectional image, which cross-sectional image is to be used among the other cross-sectional images to perform an operation.

### Second Embodiment

Since the configuration of a medical image processing apparatus 100 in the second embodiment is the same as the configuration of the medical image processing apparatus 100 in the first embodiment illustrated in FIGS. 1 and 2, the same reference signs are assigned, and descriptions thereof are omitted or simplified.

In the present embodiment, the plane generating portion 163 generates an arbitrary plane contained in volume data. For example, a reference MPR plane and an auxiliary MPR plane are generated. The reference MPR plane is an MPR plane serving as the reference for other MPR planes and is, for example, the annular plane SA described in the first embodiment. The auxiliary MPR plane is a plane that intersects with the reference MPR plane and is, for example, the longitudinal plane SF described in the first embodiment. At least one of the reference MPR plane and the auxiliary MPR plane is subjected to a predetermined process (operation) by receiving an input operation performed by a user via the UI 120. For example, the input operation is an operation of moving the lowest point of a coronary cusp or a plane described in the first embodiment. The predetermined process is, for example, a process of moving, regenerating, or redrawing the lowest point of a coronary cusp or various planes (the annular plane SA or the longitudinal planes SF), a process of generating the annular plane, or the like described in the first embodiment.

The image generating portion 164 generates various images, for example, a reference MPR image obtained by visualizing the reference MPR plane and an auxiliary MPR image obtained by visualizing the auxiliary MPR plane. The reference MPR image is, for example, the MPR image of the annular plane SA. The auxiliary MPR image is, for example, the MPR image of at least one of the longitudinal planes SF.

The display control portion 165 controls the display of an image or information and displays, for example, the reference MPR image and the auxiliary MPR image on the display 130.

The movement control portion 166 moves an arbitrary point or plane in the volume data. The movement control portion 166 may move the arbitrary point or plane by an input operation of the user via the UI 120 or move the arbitrary point or plane in conjunction with the movement of a point or plane that is different from the arbitrary point or plane. The arbitrary point may include the three lowest points of the coronary cusps. The arbitrary plane may include at least one of the reference MPR plane and the auxiliary MPR plane, that is, at least one of the annular plane SA and the longitudinal plane SF.

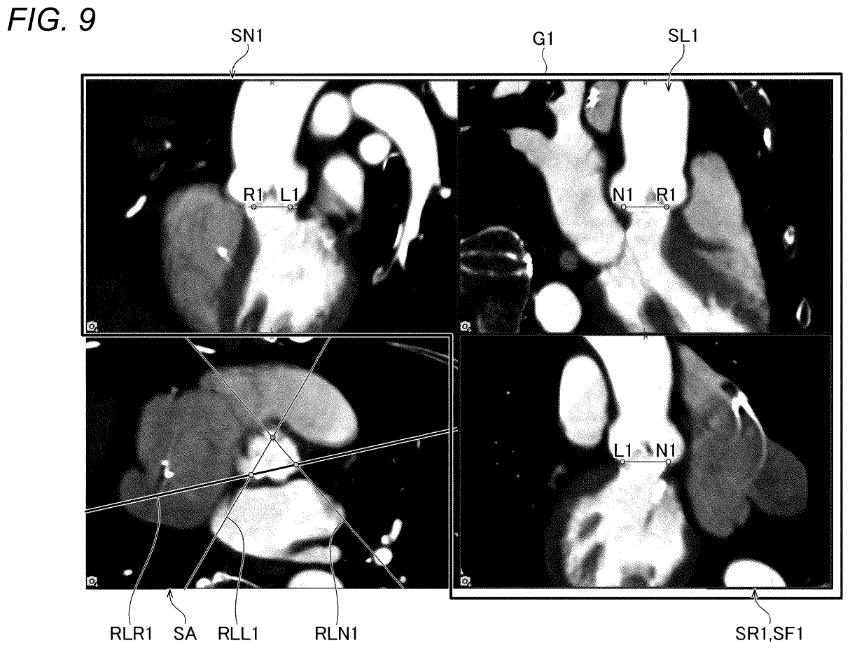

FIG. 9 is a diagram showing a first example of highlighting the reference line RL. In FIG. 9, the reference MPR image and three auxiliary MPR images are displayed. The reference MPR image is, for example, the MPR image of the annular plane SA, and the three auxiliary MPR images are, for example, the MPR images of three longitudinal planes SN1, SR1, and SL1.

In FIG. 9, the display control portion 165 receives an input via the UI 120, and the longitudinal plane SR1 is focused on. The focused longitudinal plane SF is also referred to as a focused plane SF1. Being focused may be a state in which a mouse cursor of the UI 120 is within the frame (within the window) of the MPR image of a specific plane. On the other hand, the longitudinal plane SN1 and the longitudinal plane SL1 are not focused on. The longitudinal plane SN1 and the longitudinal plane SL1 that are not focused on are also referred to as non-focused planes SF2.

On the MPR image of the annular plane SA, the positions of the three longitudinal planes SN1, SR1, and SL1 are drawn as the reference lines RLN1, RLR1, and RLL1. In this case, the display control portion 165 may draw, on the MPR image of the annular plane SA, the reference line RLR1 of the focused longitudinal plane SR1 by highlighting the reference line RLR1 more conspicuously than the reference line RLN1 of the longitudinal plane SN1 and the reference line RLL1 of the longitudinal plane SL1 that are not focused on.

Here, the highlighting may include, for example, thickening, brightening, darkening, frequently flashing, or drawing and highlighting by other drawing modes the reference line RLR1 more than the reference lines RLN1 and RLL1. For example, the reference line RL (reference line RLR1) of the focused plane SF1 may be highlighted more conspicuously than the reference lines RL (reference lines RLN1 and RLL1) of the non-focused planes SF2 by drawing and highlighting the reference line RL of the focused plane SF1 and drawing the reference lines RL of the non-focused planes SF2 as they are. The reference line RL (reference line RLR1) of the focused plane SF1 may also be highlighted more conspicuously than the reference lines RL (reference lines RLN1 and RLL1) of the non-focused planes SF2 by drawing the reference line RL of the focused plane SF1 as it is and faintly drawing the reference lines RL of the non-focused planes SF2.

According to a first example of drawing the reference lines RL described above, the medical image processing apparatus 100 draws and highlights the reference line RL representing the position of the auxiliary MPR plane which is being subjected to the operation, that is, the focused plane SF1, on the MPR image of the reference MPR plane. Therefore, the user can easily and immediately identify which auxiliary MPR plane is being used in the operation by identifying the reference lines RL.

FIG. 10 is a diagram showing a second example of highlighting the reference line RL. In FIG. 10, the reference MPR image, two offset reference MPR images, and nine auxiliary MPR images are displayed. The offset reference MPR image is an MPR image in an MPR plane obtained by performing parallel movement on the reference MPR plane in a direction perpendicular to the reference MPR plane. The offset amount is 5 mm, 10 mm, or the like, and may be another offset amount. An example of the reference MPR image is the MPR image of the annular plane SA. Examples of the nine auxiliary MPR images are the MPR images of nine longitudinal planes SF, which are the longitudinal planes SN1, SR1, SL1, SN2, SR2, SL2, SN3, SR3, and SL3.

In addition, related MPR planes are indicated as MPR planes of the same group in FIG. 10. The twelve MPR planes in FIG. 10 are divided into a reference group GS, a first group G1, a second group G2, and a third group G3. As in the first embodiment, the first group G1 includes the longitudinal planes SN1, SR1, and SL1. The second group G2 includes the longitudinal planes SN2, SR2, and SL2. The third group G3 includes the longitudinal planes SN3, SR3, and SL3. Furthermore, in addition to the annular plane SA which is the reference MPR plane, the reference group GS includes two offset annular planes SA1 and SA2 obtained by performing parallel movement on the annular plane SA in a direction perpendicular to the reference MPR plane. The offset annular planes SA1 and SA2 are examples of an offset reference MPR plane. The offset annular planes SA1 and SA2 and the MPR images thereof may be omitted.

In FIG. 10, the display control portion 165 receives an input via the UI 120, and the longitudinal plane SR3 is focused on. The other eight longitudinal planes SF are not focused on. On the MPR images of the annular plane SA and the two offset annular planes SAI and SA2 of the reference group GS, the positions of the three longitudinal planes SN3, SR3, and SL3 included in the third group G3 to which the longitudinal plane SR3, which is the focused plane SF1, belongs are drawn as the reference lines RLN3, RLR3, and RLL3. On the other hand, the positions of the six longitudinal planes SN1, SR1, SL1, SN2, SR2, and SL2 included in the first group G1 and the second group G2 to which the longitudinal plane SR3, which is the focused plane SF1, does not belong are not drawn as the reference lines RL on the MPR images of the annular plane SA and the two offset annular planes SA1 and SA2 of the reference group GS. That is, the display control portion 165 draws only the reference lines RLN3, RLR3, and RLL3 representing the positions of the longitudinal planes SN3, SR3, and SL3 included in a group including the focused plane SFI on the reference MPR image and the offset reference MPR images.

In this case, the display control portion 165 draws and highlights the reference line RLR3 of the focused longitudinal plane SR3 on the MPR images of the annular plane SA and the offset annular planes SA1 and SA2. Here, the highlighting is performed by, for example, drawing and more conspicuously highlighting the reference line RLR3 of the longitudinal plane SR3, which is the focused plane SF1, than the reference lines RLN3 and RLL3 of the longitudinal plane SN3 and the longitudinal plane SL3, which are the non-focused planes SF2 of the same third group G3. Here, the highlighting may include drawing the reference line RLR3 by, for example, thickening, brightening, darkening, or frequently flashing the reference line RLR3 more than the reference lines RLN3 and RLL3.

According to the second example of drawing the reference lines RL described above, the medical image processing apparatus 100 can prevent the observation of the reference

MPR plane from becoming difficult by restricting the number of the reference lines RL drawn on the reference MPR plane and the offset reference MPR planes even in a case where a large number of auxiliary MPR images are present. For example, the medical image processing apparatus 100 can restrict the reference lines RL to the reference lines RL of a plurality of auxiliary MPR planes that belong to the same group and are suitable for being simultaneously subjected to an input operation on the display 130 via the UI 120 and draw the reference lines RL on the reference MPR plane and the offset reference MPR planes. In this case, the user can easily confirm the reference lines RL drawn on the reference MPR plane and the offset reference MPR planes and smoothly perform an input operation on the auxiliary MPR plane or the like included in the same group as the auxiliary MPR plane which is being subjected to the operation.

Next, an operation example of the medical image processing apparatus 100 of the present embodiment is described.

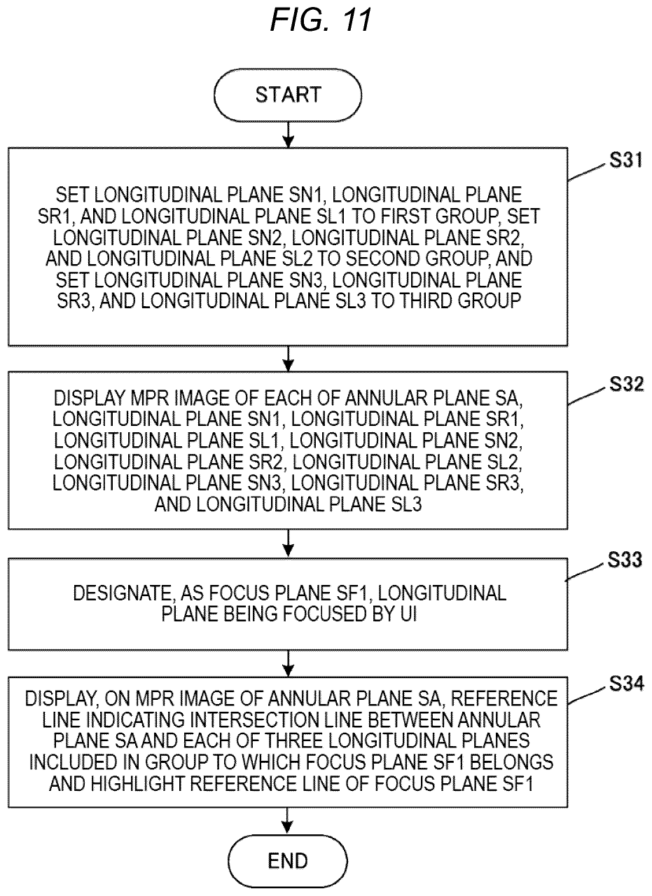

FIG. 11 is a flow chart showing an operation example of the medical image processing apparatus 100 of the present embodiment. As for the process which is same as the process shown in FIGS. 8A and 8B of the first embodiment, the same step number is assigned, and description thereof is omitted or simplified. In FIG. 11, the case of the second example shown in FIG. 10 in which a reference line is highlighted is assumed. Description of the offset annular planes SA1 and SA2 is omitted in FIG. 11. The medical image processing apparatus 100 may perform the processes in FIG. 11 in parallel with the processes shown in FIGS. 8A and 8B of the first embodiment.

First, the processing portion 160 divides a plurality of MPR planes into groups so that related MPR planes are in the same group, for example, via the UI 120. For example, the processing portion 160 sets three longitudinal planes SN1, SR1, and SL1 to the first group G1, sets three longitudinal planes SN2, SR2, and SL2 to the second group G2, and sets three longitudinal planes SN3, SR3, and SL3 to the third group G3 (S31). In addition, the processing portion 160 sets the annular plane SA to the reference group GS.

The display control portion 165 displays the MPR images of the annular plane SA and each of the nine longitudinal planes SF on the display 130 (S32).

The display control portion 165 designates the focused longitudinal plane SF as the focused plane SF1 via the UI 120 (S33). The focused plane SF1 is also referred to as a focus plane that the user focuses on. In this case, the display control portion 165 may designate the focused plane SF1 by designating an arbitrary MPR image displayed on the display via the UI 120. The focused plane SF1 may be designated by performing clicking, dragging, mouseover, various selections, or other input operations on the MPR image.

The display control portion 165 draws, on the MPR image of the annular plane SA, the intersection line between each of three longitudinal planes SF included in the group to which the focused plane SF1 belongs and the annular plane SA as the reference line RL (S34). For example, in FIG. 10, the display control portion 165 draws, on the MPR image of the annular plane SA, the intersection line between each of the three longitudinal planes SN3, SR3, and SL3 included in the third group G3 to which the longitudinal plane SR3, which is the focused plane SF1, belongs and the annular plane SA as the reference lines RLN3, RLR3, and RLL3. In this case, the display control portion 165 draws and more conspicuously highlights the reference line RLR3, which is the intersection line between the annular plane SA and the focused plane SF1, than the reference lines RLN3 and RLL3, which are the intersection lines between the annular plane SA and each of the non-focused planes SF2 in the same group (S34).

### Modification Examples of Second Embodiment

In the second embodiment, a case in which the reference plane is an MPR plane (reference MPR plane), in other words, the reference plane is planar is illustrated, but the present disclosure is not limited thereto. The plane generating portion 163 may generate a CPR plane (also referred to as a reference CPR plane), that is, a curved plane as the reference plane. As in the case of the reference MPR plane, the display control portion 165 may draw the reference line RL representing an intersection line between the annular plane SA and an auxiliary MPR plane on the reference CPR plane.

In the second embodiment, a case in which the auxiliary plane is an MPR plane (auxiliary MPR plane), in other words, the auxiliary plane is planar is illustrated, but the present disclosure is not limited thereto. The plane generating portion 163 may generate a CPR plane (also referred to as an auxiliary CPR plane), that is, a curved plane as the auxiliary plane. As in the case of the auxiliary MPR plane, the display control portion 165 may draw the reference line RL representing an intersection line between the annular plane SA and an auxiliary CPR plane on the reference plane.

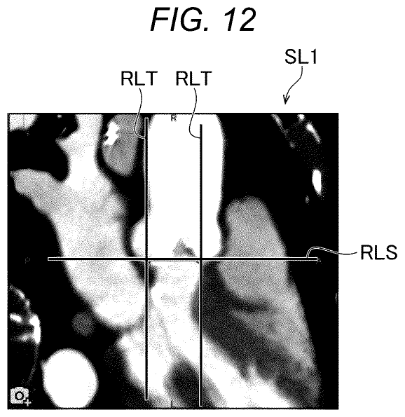

In the second embodiment, a case is mainly illustrated in which the display control portion 165 draws and highlights the reference line RL representing the position of the focused auxiliary MPR plane on the MPR image of the reference MPR plane, but the present disclosure is not limited thereto. As shown in FIG. 12, the display control portion 165 may draw, on each of the MPR images of a plurality of auxiliary MPR planes (for example, the MPR image of the longitudinal plane SL1), a reference line RLS representing the position of the reference MPR plane and a reference line RLT representing the position of one or more other auxiliary MPR planes. In a case where the MPR image of the reference MPR plane is focused on, the display control portion 165 may draw and highlight the reference line RLS representing the position of the focused reference MPR plane on at least one of the MPR images of the plurality of auxiliary MPR planes (for example, the MPR image of the longitudinal plane SL1).

In the second embodiment, three or more auxiliary MPR planes may not be perpendicular to each other. That is, each of the auxiliary MPR planes may not be in a perpendicular relationship with each other, such as the axial plane, the coronal plane, and the sagittal plane of which the directions with respect to the subject are predetermined. In addition, in a case where the plurality of auxiliary MPR planes are parallel to each other, drawing, on one auxiliary MPR plane, of the reference lines representing the positions of other auxiliary MPR planes is not performed.

In the second embodiment, the focusing may include performing, via the UI 120, clicking, mouseover, or the like on a window (inside of a frame in which the MPR image corresponding to each plane is displayed) drawn on the MPR image of the reference MPR plane or the auxiliary MPR plane. The focusing may also include performing, via the UI 120, a certain selection on the MPR image of the reference MPR plane or the auxiliary MPR plane using a button or pull-down.

In the second embodiment, at least some of the reference lines RL representing the positions of the auxiliary MPR planes that are not focused on may not be drawn on the MPR image of the reference MPR plane.

The medical image processing apparatus 100 may perform a combination of the modification examples described above.

In this way, the medical image processing apparatus 100 of the present embodiment can highlight the position in the reference plane at which the focused plane SF1 that the user currently focuses on is present with a reference line. Therefore, the user can easily identify the auxiliary plane which is currently being subjected to the operation on the reference plane.

Furthermore, the medical image processing apparatus 100 can cause only the reference lines RL of the auxiliary planes included in the group to which the focused plane SF1 belongs to be drawn even in a case where a large number of auxiliary planes are present. Therefore, the identification of the position where a plane is present is prevented from becoming difficult due to the drawing of the large amount of reference lines. Particularly, such restriction of the reference line to be drawn is useful, since the relation between the reference plane and a plurality of auxiliary planes is easily lost when the auxiliary planes are in an unconstrained relation with each other, even in a case where the large number of auxiliary planes are in an unordered relation instead of an ordered relation and where each of the auxiliary planes is arranged according to a certain condition with respect to the reference plane.

The first embodiment, the modification examples of the first embodiment, the second embodiment, and the modification examples of the second embodiment may be arbitrarily combined.

Hereinabove, various embodiments have been described with reference to the drawings, but it is needless to say that the present disclosure is not limited to such examples. It is apparent that those skilled in the art can make various modifications or revisions within the scope of the claims, and it is understood that such modifications or revisions also naturally fall within the technical scope of the present disclosure.

Moreover, the medical image processing apparatus 100 may at least include the processor 140 and the memory 150. The port 110, the UI 120, and the display 130 may be external to the medical image processing apparatus 100.

Furthermore, a case is illustrated in which volume data is transmitted from the CT apparatus 200 to the medical image processing apparatus 100 as a captured CT image. Alternatively, the volume data may be transmitted to a server (for example, an image data server (PACS)) (not shown) on the network to be stored, so as to accumulate the volume data first. In this case, the port 110 of the medical image processing apparatus 100 may acquire the volume data from the server or the like via a wired circuit or a wireless circuit or acquire the volume data via an arbitrary storage medium (not shown) when necessary.

Furthermore, a case is illustrated in which the volume data is transmitted, as a captured CT image, from the CT apparatus 200 to the medical image processing apparatus 100 via the port 110. Such a case also includes a case where the CT apparatus 200 and the medical image processing apparatus 100 are practically combined to be formed as one product. In addition, the case also includes a case where the medical image processing apparatus 100 is handled as a console of the CT apparatus 200.

Furthermore, a case is illustrated in which volume data containing information on the inside of a subject is generated by capturing an image with the CT apparatus 200, but the volume data may also be generated by capturing an image with another apparatus. Another apparatus includes a magnetic resonance imaging (MRI) apparatus, a positron emission tomography (PET) apparatus, an angiography apparatus, or apparatuses of other modalities. In addition, the PET apparatus may be used in combination with an apparatus of another modality.

Moreover, the operation in the medical image processing apparatus 100 can be represented as a prescribed medical image processing method. The operation can also be represented as a program for causing a computer to execute each step in the medical image processing method.

### Summary of Above Embodiments

Based on the above, at least the following matters are described in the present disclosure. The corresponding constituents in the embodiments described above are provided in parentheses as examples, but the present disclosure is not limited thereto.

### [Item 1]

A medical image processing apparatus (medical image processing apparatus 100) including a processor (processor 140), in which the processor is configured to acquire volume data containing three cusp-shaped structures of a subject, set three end points (lowest points of coronary cusps, lowest point N1 of NCC, lowest point R1 of RCC, and lowest point L1 of LCC) on the most upstream sides of the respective three cusp-shaped structures in the volume data, set a reference plane (annular plane SA) containing the three end points, set a first plane (longitudinal plane SN1) that is a plane which contains one or two end points among the three end points and which is perpendicular to the reference plane, set a second plane (longitudinal plane SR1) that is a plane which contains, among the three end points, one or two end points different from the one end point or the combination of the two end points of the first plane and containing all of the three end points together with the end points of the first plane and which is perpendicular to the reference plane, display a reference image (MPR image of annular plane SA) obtained by visualizing the reference plane on a display (display 130) along with the three end points contained in the reference plane, display a first image (MPR image of a longitudinal plane SN1) obtained by visualizing the first plane on the display simultaneously with the reference image, along with the one or two end points contained in the first plane, display a second image (MPR image of a longitudinal plane SR1) obtained by visualizing the second plane on the display simultaneously with the reference image, along with the one or two end points contained in the second plane, receive an input operation of moving at least one of the three end points via user interface (UI 120), and update the reference plane by moving at least one of the three end points based on the input operation.

With such a configuration, the medical image processing apparatus can increase the accuracy of the position or direction of the reference plane by adjusting the positions of the three end points using the UI 120, and the adjustment can be suitably performed. Furthermore, the user instructs the movement of the three end points while confirming the reference image, the first image, or the second image, and the result thereof can be confirmed by the display of the result. Therefore, the user can confirm that the display of the reference image, the first image, or the second image has been updated by, for example, moving at least one of the three end points. Therefore, the user can execute the movement operation while sequentially confirming whether the movement of at least one of the three end points has caused the other end points to be displaced from the lowest points or the like. Furthermore, the medical image processing apparatus can suitably determine the reference plane, since all of the three end points can be suitably determined. Therefore, the accuracy of determining a plane serving as an index in a site in a subject having three or more cusp-shaped structures can be improved.

### [Item 2]

The medical image processing apparatus according to item 1, in which the reference plane is an annular plane, the three cusp-shaped structures are a non-coronary cusp (NCC) of an aortic valve, a right coronary cusp (RCC) of the aortic valve, and a left coronary cusp (LCC) of the aortic valve, and the three end points are the lowest points of the respective coronary cusps.

Such a configuration allows the medical image processing apparatus to measure the annular plane with high accuracy and measure the perimeter or the diameter of the annular plane with high accuracy. Therefore, the medical image processing apparatus can suitably determine the size of the artificial valve that replaces the aortic valve. The medical image processing apparatus can therefore prevent the coronary artery arising near the aortic valve from being obstructed by the artificial valve. The medical image processing apparatus can also prevent the artificial valve from falling off due to the small size of the artificial valve.

### [Item 3]

The medical image processing apparatus according to item 1 or 2, in which the processor is configured to update the reference plane by moving at least one of the three end points on the first plane or the second plane containing at least one of the three end points via the user interface.

Such a configuration allows the user to intuitively adjust the reference plane by moving any one of the end points on the first plane or the second plane via the user interface.

### [Item 4]

The medical image processing apparatus according to item 1 or 2, in which at least one of the reference plane, the first plane, and the second plane is a plane to be moved, and the processor is configured to update the reference image, the first image, and the second image by subjecting the plane to be moved to parallel movement in a direction perpendicular to the plane to be moved via the user interface, move at least one of the three end points so that at least one of the three end points contained in the plane to be moved before the parallel movement is contained in the plane to be moved after the parallel movement, and update the reference plane according to the movement of at least one of the three end points.

Such a configuration allows the user to intuitively adjust the reference plane by moving the plane to be moved via the user interface, whereby the end point can also be indirectly moved.

### [Item 5]

The medical image processing apparatus according to any one of items 1 to 4, in which the processor is configured to set a third plane (longitudinal plane SL1) that is a plane which contains one or two end points among the three end points and which is perpendicular to the reference plane, the first plane contains a first end point (lowest point of RCC) and a second end point (lowest point of LCC) among the three end points, the second plane contains the second end point and a third end point (lowest point of NCC) among the three end points, and the third plane contains the third end point and the first end point among the three end points.

Such a configuration allows the medical image processing apparatus to set the first plane and the second plane containing as many end points as possible and adjust the reference plane using the first plane and the second plane.

### [Item 6]

The medical image processing apparatus according to any one of items 1 to 4, in which the processor is configured to set a third plane that is a plane which contains one or two end points among the three end points and which is perpendicular to the reference plane, the first plane contains a first end point (lowest point of NCC) among the three end points and an incenter (incenter O) of a triangle (triangle TR) of which the vertices are the three end points, the second plane contains a second end point (lowest point of RCC) among the three end points and the incenter, and the third plane contains a third end point (lowest point of LCC) among the three end points and the incenter.

Such a configuration allows the medical image processing apparatus to set the first plane and the second plane containing the end points and adjust the reference plane using the first plane and the second plane. In addition, more accurate adjustment of the reference plane can be facilitated by complementally using the first plane and the second plane along with the plane containing more end points.

### [Item 7]

The medical image processing apparatus according to any one of items 1 to 4, in which the processor is configured to set a third plane that is a plane which contains one or two end points among the three end point and which is perpendicular to the reference plane, the first plane contains a first end point (lowest point of NCC) among the three end points and is perpendicular to a first straight line that connects the first end point to an incenter of a triangle of which the vertices are the three end points, the second plane contains a second end point (lowest point of RCC) among the three end points and is perpendicular to a second straight line that connects the second end point to the incenter, and the third plane contains a third end point (lowest point of LCC) among the three end points and is perpendicular to a third straight line that connects the third end point to the incenter.

Such a configuration allows the medical image processing apparatus to set the first plane and the second plane containing the end points and adjust the reference plane using the first plane and the second plane. In addition, more accurate adjustment of the reference plane can be facilitated by complementally using the first plane and the second plane along with the plane containing more end points.

### [Item 8]

A medical image processing method including: a step of acquiring volume data containing three cusp-shaped structures of a subject; a step of setting three end points on the most upstream sides of the respective three cusp-shaped structures in the volume data; a step of setting a reference plane containing the three end points; a step of setting a first plane that is a plane which contains one or two end points among the three end points and which is perpendicular to the reference plane; a step of setting a second plane that is a plane which contains, among the three end points, one or two end points different from the one end point or the combination of the two end points of the first plane and containing all of the three end points together with the end points of the first plane and which is perpendicular to the reference plane; a step of displaying a reference image obtained by visualizing the reference plane on a display along with the three end points contained in the reference plane; a step of displaying a first image obtained by visualizing the first plane on the display simultaneously with the reference image, along with the one or two end points contained in the first plane; a step of displaying a second image obtained by visualizing the second plane on the display simultaneously with the reference image, along with the one or two end points contained in the second plane; a step of receiving an input operation of moving at least one of the three end points via user interface; and a step of updating the reference plane by moving at least one of the three end points based on the input operation.

Such a configuration allows the medical image processing method to produce the same effects as those of Item 1.

### [Item 9]

A computer-readable non-transient storage medium storing a medical image processing program for causing a computer to execute the medical image processing method according to item 8.

Such a configuration allows the computer-readable non-transient storage medium to produce the same effects as those of Item 1.

The present disclosure is useful for a medical image processing apparatus, a medical

image processing method, and a storage medium storing a medical image processing program that can improve the accuracy of determining a plane serving as an index in a site in a subject having three or more cusp-shaped structures.

What is claimed is:

1. A medical image processing apparatus comprising:
a processor,
wherein the processor is configured to
acquire volume data containing three cusp-shaped structures of a subject,
set three end points on the most upstream sides of the respective three cusp-shaped structures in the volume data,
set a reference plane containing the three end points,
set a first plane that is a plane which contains one or two end points among the three end points and which is perpendicular to the reference plane,
set a second plane that is a plane which contains, among the three end points, one or two end points different from the one end point or the combination of the two end points of the first plane and containing all of the three end points together with the end points of the first plane and which is perpendicular to the reference plane,
display a reference image obtained by visualizing the reference plane on a display along with the three end points contained in the reference plane,
display a first image obtained by visualizing the first plane on the display simultaneously with the reference image, along with the one or two end points contained in the first plane,
display a second image obtained by visualizing the second plane on the display simultaneously with the reference image, along with the one or two end points contained in the second plane,
receive an input operation of moving at least one of the three end points via user interface, and
update the reference plane by moving at least one of the three end points based on the input operation.

2. The medical image processing apparatus according to claim 1, wherein
the reference plane is an annular plane,
the three cusp-shaped structures are a non-coronary cusp of an aortic valve, a right coronary cusp of the aortic valve, and a left coronary cusp of the aortic valve, and
the three end points are the lowest points of the respective coronary cusps.

3. The medical image processing apparatus according to claim 1, wherein
the processor is configured to update the reference plane by moving at least one of the three end points on the first plane or the second plane containing at least one of the three end points via the user interface.

4. The medical image processing apparatus according to claim 1, wherein
at least one of the reference plane, the first plane, and the second plane is a plane to be moved, and
the processor is configured to
update the reference image, the first image, and the second image by subjecting the plane to be moved to parallel movement in a direction perpendicular to the plane to be moved via the user interface,
move at least one of the three end points so that at least one of the three end points contained in the plane to be moved before the parallel movement is contained in the plane to be moved after the parallel movement, and
update the reference plane according to the movement of at least one of the three end points.

5. The medical image processing apparatus according to claim 1, wherein
the processor is configured to set a third plane that is a plane which contains one or two end points among the three end points and which is perpendicular to the reference plane,
the first plane contains a first end point and a second end point among the three end points,
the second plane contains the second end point and a third end point among the three end points, and
the third plane contains the third end point and the first end point among the three end points.

6. The medical image processing apparatus according to claim 1, wherein
the processor is configured to set a third plane that is a plane which contains one or two end points among the three end points and which is perpendicular to the reference plane,
the first plane contains a first end point among the three end points and an incenter of a triangle of which the vertices are the three end points,
the second plane contains a second end point among the three end points and the incenter, and
the third plane contains a third end point among the three end points and the incenter.

7. The medical image processing apparatus according to claim 1, wherein
the processor is configured to set a third plane that is a plane which contains one or two end points among the three end point and which is perpendicular to the reference plane,
the first plane contains a first end point among the three end points and is perpendicular to a first straight line that connects the first end point to an incenter of a triangle of which the vertices are the three end points,
the second plane contains a second end point among the three end points and is perpendicular to a second straight line that connects the second end point to the incenter, and
the third plane contains a third end point among the three end points and is perpendicular to a third straight line that connects the third end point to the incenter.

8. A medical image processing method comprising:
a step of acquiring volume data containing three cusp-shaped structures of a subject;
a step of setting three end points on the most upstream sides of the respective three cusp-shaped structures in the volume data;
a step of setting a reference plane containing the three end points;
a step of setting a first plane that is a plane which contains one or two end points among the three end points and which is perpendicular to the reference plane;
a step of setting a second plane that is a plane which contains, among the three end points, one or two end points different from the one end point or the combination of the two end points of the first plane and containing all of the three end points together with the end points of the first plane and which is perpendicular to the reference plane;
a step of displaying a reference image obtained by visualizing the reference plane on a display along with the three end points contained in the reference plane;
a step of displaying a first image obtained by visualizing the first plane on the display simultaneously with the reference image, along with the one or two end points contained in the first plane;
a step of displaying a second image obtained by visualizing the second plane on the display simultaneously with the reference image, along with the one or two end points contained in the second plane;
a step of receiving an input operation of moving at least one of the three end points via user interface; and
a step of updating the reference plane by moving at least one of the three end points based on the input operation.

9. A computer-readable non-transient storage medium storing a medical image processing program for causing a computer to execute the medical image processing method according to claim 8.
